(19) United States
(12) Patent Application Publication
(10) Pub. No.: US 2003/0180045 A1
(43) Pub. Date: Sep. 25, 2003

(54) System and method for optical transmission

(75) Inventor: Akio Tajima, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/385,849

(22) Filed: Mar. 12, 2003

(30) Foreign Application Priority Data
Mar. 22, 2002 (JP) 2002-079956

(51) Int. Cl. H04B 10/24

(52) U.S. Cl. 398/42; 398/79

(57) ABSTRACT

A system and method for bidirectional optical transmission in one optical fiber with large transmission capacity, enabling the enlargement of transmission distance. Downward optical signals sent from one or more downward optical signal transmitters are received by one or more downward optical signal receivers via an optical fiber transmission line and upward/downward signal separating multiplexer—demultiplexers. On the other hand, upward optical signals sent from one or more upward optical signal transmitters are received by one or more upward optical signal receivers by following the opposite route. Output signals from the downward optical signal transmitter leak in the upward optical signal receiver via the upward/downward signal separating multiplexer—demultiplexer. However, there is a large difference between the frequency of the upward optical signals and that of the downward optical signals, and beat/noise components produced by interference in the two wavelengths are present outside the band of the upward optical signal receiver, thus avoiding the influence of coherent crosstalk. Additionally, power crosstalk also does not become a problem because of large isolation.

### FIELD OF THE INVENTION

The present invention relates to a system and method for optical transmission suitable for use in an optical communication system, etc. which constitutes a large scale high-speed network, and more particularly to a system and method for duplex or bidirectional optical transmission in one optical fiber.

### BACKGROUND OF THE INVENTION

Two optical fibers, one for upward signals and the other for downward signals, have been used in communications by high-speed optical signals with a transmission speed of more than 1 Gbps (gigabits per second) or optical signals obtained by wavelength-division multiplexing (WDM) the high-speed optical signals so as to avoid mutual interference between upward and downward optical signals.

On the other hand, there are single-fiber bidirectional (duplex) optical transmission techniques for transmitting upward and downward optical signals in one optical fiber. With the techniques, necessary optical fibers can be reduced by half. Thus, it is possible to construct an optical transmission system at low cost. Similarly, in the case of services through dark fibers, only half the fibers used in two-fiber transmission are required, which brings costs down.

Such bidirectional optical transmission using one optical fiber is prepared for transmission speeds of up to a few hundred Mbps (megabits per second). In the bidirectional optical transmission, wavelengths are assigned by 10 nm (nanometer), namely, frequency bands are assigned for upward and downward transmissions (for example, the 1310 nm band is assigned for upward transmission and the 1550 nm band for downward transmission) considering miniaturization of transmission devices and economization. Upward signals and downward signals can be separated by differentiating their wavelengths. That is, in the bidirectional optical transmission using one optical fiber, it is possible to adopt components such as a WDM coupler that do not have a high degree of accuracy.

Besides, the conventional techniques are not envisioned for long-distance transmission. Accordingly, in the conventional bidirectional optical transmission, optical transmitters execute direct modulation with the use of the Fabry-Perot (FP) laser diode (LD). As to the optical transmitter and optical receiver, it has been likely to employ a single-unit optical transmitter-receiver to which an optical fiber dedicated to bidirectional optical transmission is connected because of its ease of use.

As described above, in the conventional bidirectional optical transmission, upward and downward signals are separated according to the frequency bands. Consequently, transmisson capacity cannot be enlarged by multiplexing a plurality of wavelengths in a frequency band. In addition, there is another problem that transmission distance is limited by a loss of 0.5 dB/km in the 1310 nm band, and tolerable losses in the optical fiber, namely, transmission distance cannot be increased by an erbium dope optical fiber amplifier (EDFA).

Moreover, when parts or components for separating upward and downward signals is provided with poor isolation, a distributed feedback (DFB) laser or an integrated electroabsorption (EA) modulator light source employed for covering a few score kilometers of high-speed transmission at a speed of over 1 Gbps is tend to make an error easily by the influence of return light as compared to the Fabry-Perot laser diode. Additionally, an error occurs in signal regeneration due to leakage light from an optical transmitter to optical receiver in the same device. Furthermore, when transmitter optical power is increased for longer distance transmission, induced Brillouin scattering occurs in the opposite direction of optical signals, which affects the optical transmitter and optical receiver, thereby causing an error.

### SUMMARY OF THE INVENTION

It is therefore an object of the present invention to provide a system and method for the single-fiber bidirectional optical transmission with large transmisson capacity, enabling a reduction of necessary fibers and enlargement of transmission distance.

In accordance with the first aspect of the present invention, to achieve the above object, there is provided an optical transmission system comprising: an optical fiber; a downward optical signal transmitter for sending downward optical signals at transmission power lower than an induced Brilloum scattering threshold; a downward optical signal receiver for receiving the downward optical signals sent from the downward optical signal transmitter via the optical fiber; an upward optical signal transmitter for sending upward optical signals at transmission power lower than the induced Brillouin scattering threshold; and an upward optical signal receiver for receiving the upward optical signals sent from the upward optical signal transmitter via the optical fiber; wherein the difference between the frequency of the upward optical signal sent from the upward optical signal transmitter and the frequency of the downward optical signal sent from the downward optical signal transmitter is greater than bandwidths assigned to the downward optical signal receiver and the upward optical signal receiver.

That is, in accordance with the first aspect of the present invention, the difference between the frequencies of the downward optical signal and upward optical signal transmitted via the optical fiber is set greater than bandwidths assigned to the downward optical signal receiver and the upward optical signal receiver, and transmission power for the optical signals is lower than the induced Brilloum scattering threshold, thus realizing the single-fiber bidirectional optical transmission with large transmission capacity, in which the number of necessary fibers can be reduced.

In accordance with the second aspect of the present invention, there is provided an optical transmission system comprising: an optical fiber; a plurality of downward optical signal transmitters each sending downward optical signals of a different frequency at transmission power lower than an induced Brillouin scattering threshold; a plurality of downward optical signal receivers each receiving the downward optical signals sent from the respective downward optical signal transmitters via the optical fiber according to each frequency; a plurality of upward optical signal transmitters each sending upward optical signals of a different frequency at transmission power lower than the induced Brillouin scattering threshold; and a plurality of upward optical signal receivers each receiving the upward optical signals sent from the respective upward optical signal transmitters via the optical fiber according to each frequency; wherein the difference between the frequency of the upward optical signal sent from each upward optical signal transmitter and the frequency of the downward optical signal sent from each downward optical signal transmitter is greater than entire bandwidths assigned to the downward optical signal receivers and the upward optical signal receivers.

That is, in accordance with the second aspect of the present invention, the difference between the frequencies of the respective downward optical signals and upward optical signals transmitted via the optical fiber is set greater than bandwidths assigned to all the downward optical signal receivers and the upward optical signal receivers, and transmission power for the optical signals is lower than the induced Brillouin scattering threshold, thus realizing the single-fiber bidirectional optical transmission with large transmission capacity, in which the number of necessary fibers can be reduced.

In accordance with the third aspect of the present invention, in the first or second aspect, the optical transmission system further comprises a plurality of optical multiplexer—demultiplexers for making a separation between the upward optical signals and downward optical signals.

That is, in accordance with the third aspect of the present invention, the optical multiplexer—demultiplexer is employed for making a separation between the upward optical signals and downward optical signals transmitted in the optical fiber, which imposes limitations on bands allocated to the signals after the separation. Therefore, an optical amplifier just needs to satisfy requirements such as a gain flatness characteristic in the limited bands, thus facilitating the manufacture of the optical amplifier. In addition, it is possible to prevent reflected wave produced in a transmission line from traveling in a backward direction toward the receiver.

In accordance with the fourth aspect of the present invention, in the first or second aspect, the optical transmission system further comprises a plurality of optical circulators for making a separation between the upward optical signals and downward optical signals.

That is, in accordance with the fourth aspect of the present invention, the optical circulator is employed for making a separation between the upward optical signals and downward optical signals transmitted in the optical fiber, which eases restrictions on the wavelengths of upward and downward signals.

In accordance with the fifth aspect of the present invention, in the first or second aspect, the optical transmission system further comprises a plurality of optical interleavers for making a separation between the upward optical signals and downward optical signals.

That is, in accordance with the fifth aspect of the present invention, the optical interleaver is employed for making a separation between the upward optical signals and downward optical signals transmitted in the optical fiber, which enables an enlargement of each gap between the wavelengths of both upward and downward signals. Consequently, optical components can be produced at low cost. In addition, it is possible to prevent reflected wave produced in a transmission line from traveling in a backward direction toward the receiver.

In accordance with the sixth aspect of the present invention, in the second aspect, the optical transmission system further comprises a plurality of upward amplifiers for amplifying the upward optical signals of different frequencies after multiplexing operation and a plurality of downward amplifiers for amplifying the downward optical signals of different frequencies after multiplexing operation.

That is, in accordance with the sixth aspect of the present invention, the optical amplifiers are employed for amplifying the multiplexed upward optical signals and downward optical signals of different frequencies, which add to a loss margin. Consequently, transmission distance can be increased.

In accordance with the seventh aspect of the present invention, in the sixth aspect, the upward amplifiers and the downward amplifiers are erbium dope optical fiber amplifiers (EDFA).

That is, in accordance with the seventh aspect of the present invention, the direct amplification of signals is carried out through the use of the erbium dope optical fiber amplifiers.

In accordance with the eighth aspect of the present invention, there is provided an optical transmission method for transmitting optical signals in both upward and downward directions in one and the same fiber, wherein the difference between the frequency of upward optical signals and the frequency of downward optical signals is greater than bandwidths assigned to all receivers for receiving the optical signals, and transmission power of the optical signals is lower than an induced Brillouin scattering threshold.

That is, in accordance with the eighth aspect of the present invention, the difference between the frequencies of the upward optical signal and downward optical signal is set greater than bandwidths assigned to all the receivers for receiving the optical signals, and transmission power of the optical signals is lower than the induced Brillouin scattering threshold, thus realizing the single-fiber bidirectional optical transmission with large transmission capacity, in which the number of necessary fibers can be reduced.

In accordance with the ninth aspect of the present invention, there is provided an optical transmission method for transmitting optical signals of different frequencies in both upward and downward directions in one and the same fiber, wherein the differences between the respective frequencies of the upward optical signals and the respective frequencies of the downward optical signals are greater than bandwidths assigned to all receivers for receiving the optical signals, and transmission power of the optical signals is lower than an induced Brillouin scattering threshold.

That is, in accordance with the ninth aspect of the present invention, the differences between the frequencies of the respective downward and upward optical signals are set greater than bandwidths assigned to all the receivers for receiving the optical signals, and transmission power of the optical signals is lower than the induced Brillouin scattering threshold, thus realizing the single-fiber bidirectional optical transmission with large transmission capacity, in which the number of necessary fibers can be reduced.

### BRIEF DESCRIPTION OF THE DRAWINGS

The objects and features of the present invention will become more apparent from the consideration of the following detailed description taken in conjunction with the accompanying drawings in which:

FIG. 1 is a diagram schematically showing the configuration of a bidirectional optical transmission system according to the first embodiment of the present invention;

FIG. 2 is a graph showing the frequency band characteristic of optical signal receivers depicted in FIG. 1;

FIG. 3 is a diagram illustrating the allocation relationship between an upward optical signal and a downward optical signal in the bidirectional optical transmission system depicted in FIG. 1;

FIG. 4 is a diagram schematically showing the configuration of a bidirectional optical transmission system according to the second embodiment of the present invention;

FIG. 5 is a diagram illustrating the insertion loss of an optical circulator for multiplexing—demultiplexing upward and downward optical signals depicted in FIG. 4;

FIG. 6 is a diagram schematically showing the configuration of a bidirectional optical transmission system according to the third embodiment of the present invention;

FIG. 7 is a diagram illustrating the general configuration of an interleaver depicted in FIG. 6;

FIG. 8 is a diagram schematically showing the configuration of a bidirectional optical transmission system according to the fourth embodiment of the present invention;

FIG. 9 is a diagram illustrating relationships between transparency characteristics of upward/downward signal separating multiplexer—demultiplexers and the wavelength of each optical signal in the bidirectional optical transmission system depicted in FIG. 8;

FIG. 10 is a diagram schematically showing the configuration of a bidirectional optical transmission system according to the fifth embodiment of the present invention;

FIG. 11 is a diagram schematically showing the configuration of a bidirectional optical transmission system according to the sixth embodiment of the present invention;

FIG. 12 is a diagram illustrating relationships between the wavelength of each optical signal and transparency characteristics of an upward signal multiplexer, a downward signal multiplexer, an upward signal demultiplexer and downward signal demultiplexer in the bidirectional optical transmission system depicted in FIG. 11;

FIG. 13 is a diagram schematically showing the configuration of a bidirectional optical transmission system according to the seventh embodiment of the present invention;

FIG. 14 is a diagram illustrating the allocation relationship between the wavelengths of optical signals in the bidirectional optical transmission system depicted in FIG. 13;

FIG. 15 is a diagram schematically showing the configuration of a bidirectional optical transmission system according to the eighth embodiment of the present invention; and

FIG. 16 is a diagram schematically showing the configuration of a bidirectional optical transmission system according to the ninth embodiment of the present invention.

### DESCRIPTION OF THE PREFERRED EMBODIMENT

Referring now to the drawings, a description of preferred embodiments of the present invention will be given in detail.

First Embodiment

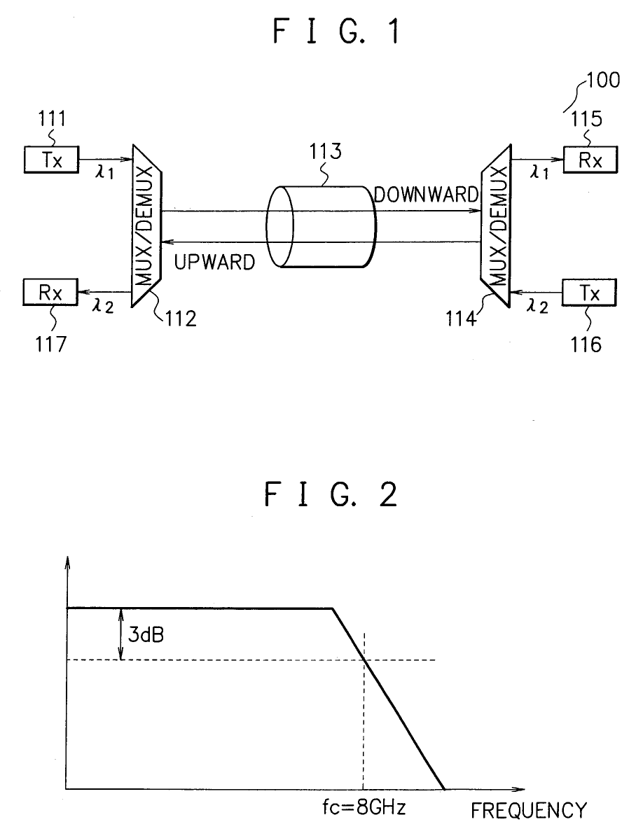

FIG. 1 is a diagram schematically showing the configuration of a bidirectional optical transmission system according to the first embodiment of the present invention. Referring to FIG. 1, the bidirectional optical transmission system 100 comprises a downward optical signal transmitter (Tx) 111, a first upward/downward signal separating multiplexer—demultiplexer (hereinafter referred to as first MUX/DEMUX) 112, an optical fiber transmission line 113, a second upward/downward signal separating multiplexer demultiplexer (hereinafter referred to as second MUX/DEMUX) 114, a downward optical signal receiver (Rx) 115, an upward optical signal transmitter 116, and an upward optical signal receiver 117. The downward optical signal receiver 115 and upward optical signal receiver 117 receive downward and upward optical signals sent from the downward optical signal transmitter 111 and upward optical signal transmitter 116, respectively, via the first MUX/DEMUX 112, optical fiber transmission line 113, and second MUX/DEMUX 114.

In the bidirectional optical transmission system 100 of the first embodiment, both upward optical signals and downward optical signals are transmitted at a rate of 10 Gbps. The wavelength λ₁ of the downward optical signal is 1552. 52 nm (frequency f₁: 193. 10 THz (terahertz)), while the wavelength λ₂ of the upward optical signal is 1555. 75 nm (frequency f₂: 192.70 THz). Besides, output power of the optical transmitters 111 and 116 is 0 dBm, and the allowable reflected return light of them is 25 dB.

FIG. 2 is a graph showing the band characteristic of the optical signal receivers 115 and 117. As can be seen in FIG. 2, the upward optical signal receiver 117 and downward optical signal receiver 115 are each assigned a frequency band of 8 GHz. The first and second MUX/DEMUXs 112 and 114 are characterized by having an insertion loss of 4 dB, inter-channel isolation of 35 dB, directivity (output components that leak from one port to the other) of 55 dB, and a pass band of 0.5 nm for each channel. Transmission loss in the optical fiber transmission line 113 is 6 dB.

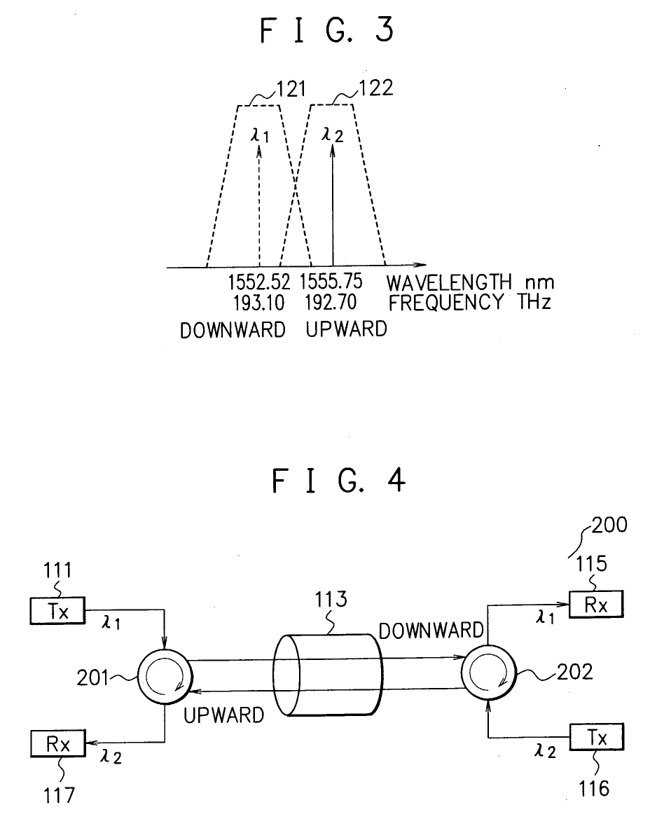

FIG. 3 is a diagram illustrating the allocation relationship between the upward optical signal and downward optical signal in this embodiment. In other words, FIG. 3 is a diagram illustrating relationships between transparency or transmission characteristics of the first and second MUX/DEMUXs 112 and 114 and the upward optical signal wavelength λ₂: 1555. 75 nm (frequency f₂: 192.70 THz) and the downward optical signal wavelength λ₁: 1552. 52 nm (frequency f₁: 193. 10 THz). The first and second MUX/DEMUXs 112 and 114 have the same transparency characteristics. In FIG. 3, the transparency characteristic regarding wavelength λ₁ is indicated by dotted line 121 and that regarding wavelength λ₂ is indicated by dotted line 122.

Output signals from the downward optical signal transmitter 111 leak in the upward optical signal receiver 117 through the first MUX/DEMUX 112. Since the directivity of the first MUX/DEMUX 112 is assumed to be 55 dB in this embodiment, an optical signal of about −55 dBm sneaks into the upward optical signal receiver 117. Thus, the power of upward optical signals of wavelength λ₂ input to the upward optical signal receiver 117 becomes −14 dBm. Besides, the difference between the wavelength λ₁ (frequency f₁) and the wavelength λ₂ (frequency f₂) is about 3.2 nm (frequency difference: 400 GHz), and beat/noise components produced by interference in the two wavelengths λ₁ and λ₂ are present outside the 8 GHz band of the upward optical signal receiver 117. Thus, the upward optical signal receiver 117 is free from the influence of coherent crosstalk. In addition, there is a gap of more than 40 dB between the signal levels of the input and output signals, and therefore a problem of power crosstalk is also insignificant.

Similarly, there is no problem about the case where output signals from the upward optical signal transmitter 116 leak in the downward optical signal receiver 115 through the second MUX/DEMUX 114.

On the other hand, output signals from the upward optical signal transmitter 116 leak in the downward optical signal transmitter 111 through the first MUX/DEMUX 112. However, since the first MUX/DEMUX 112 is provided with an isolation of 35 dB, the power of the leakage signals is less than −45 dBm, thus having little influence.

In like wise, there is no problem about the case where output signals from the downward optical signal transmitter 111 leak in the upward optical signal transmitter 116 through the second MUX/DEMUX 114.

Additionally, transmission optical power is set lower than an induced Brillouin scattering threshold, thus causing no influence of the induced Brillouin scattering. Incidentally, the induced Brillouin scattering is a phenomenon, in which most of optical signals are reflected at an incident point, produced when optical power greater than a certain power (threshold) is input in an optical fiber. In the first embodiment of the present invention, the bidirectional optical transmission of 10 Gbps can be realized by suppressing the influence of the induced Brilloum scattering.

Second Embodiment

FIG. 4 is a diagram schematically showing the configuration of a bidirectional optical transmission system according to the second embodiment of the present invention. In FIG. 4, the same parts as shown in FIG. 1 are designated by similar numerals, and may not require any further explanation. Referring to FIG. 4, the bidirectional optical transmission system 200 comprises a downward optical signal transmitter 111, a first upward/downward signal separating optical circulator (hereinafter referred to as first optical circulator) 201, an optical fiber transmission line 113, a second upward/downward signal separating optical circulator (hereinafter referred to as second optical circulator) 202, a downward optical signal receiver 115, an upward optical signal transmitter 116, and an upward optical signal receiver 117. The downward optical signal receiver 115 and upward optical signal receiver 117 receive downward and upward optical signals sent from the downward optical signal transmitter 111 and upward optical signal transmitter 116, respectively, via the first optical circulator 201, optical fiber transmission line 113, and second optical circulator 202.

In the bidirectional optical transmission system 200 of the second embodiment, both upward optical signals and downward optical signals are transmitted at a rate of 10 Gbps. The wavelength λ₁ of the downward optical signal is 1552. 52 nm (frequency f₁: 193. 10 THz), while the wavelength λ₂ of the upward optical signal is 1555. 75 nm (frequency f₂: 192.70 THz). Besides, the upward optical signal receiver 117 and downward optical signal receiver 115 are each assigned the frequency band of 8 GHz.

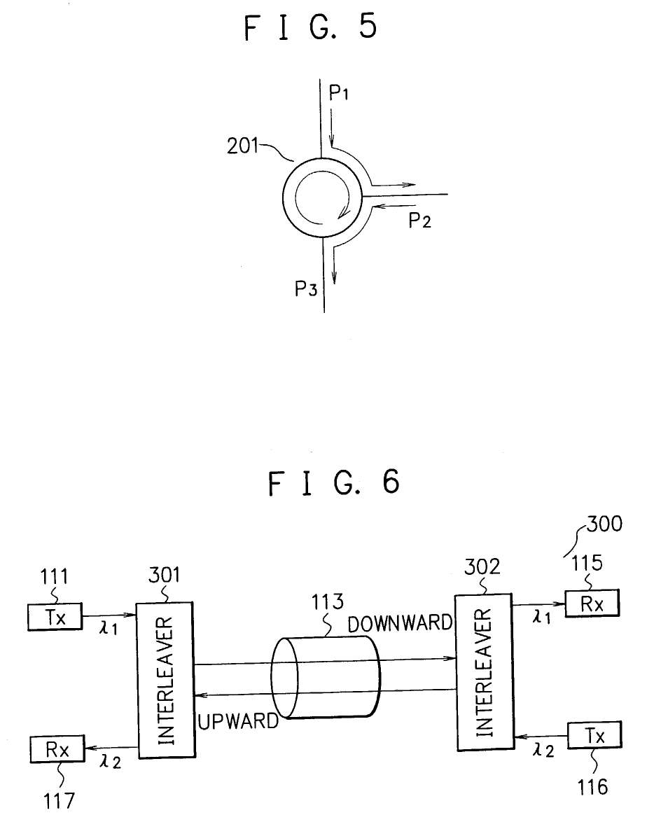

FIG. 5 is a diagram illustrating the insertion loss of the first optical circulator 201. The second optical circulator 202 is the same in configuration as the first optical circulator 201, and therefore does not require any further explanation. The first optical circulator 201 includes a first port P₁ for inputting downward optical signals sent from the downward optical signal transmitter 111, a second port P₂ for outputting the downward optical signals input from the first port P₁ to the optical fiber transmission line 113 as well as inputting upward optical signals sent through the optical fiber transmission line 113, and a third port P₃ for outputting the upward optical signals input from the second port P₂.

The first optical circulator 201 is characterized by having an insertion loss of 1 dB in a direction from the first port P₁ to the second port P₂ and in a direction from the second port P₂ to the third port P₃. In addition, the first optical circulator 201 is provided with an isolation of 40 dB in a direction from the second port P₂ to the first port P₁ as well as in a direction from the third port P₃ to the second port P₂, and directivity of 60 dB in a direction from the first port P₁ to the third port P₃ and in the opposite direction thereof. Besides, the used frequency band is located at 1525 nm to 1565 nm. Transmission loss in the optical fiber transmission line 113 is 13 dB.

Output signals from the downward optical signal transmitter 111 leak in the upward optical signal receiver 117 through the first optical circulator 201. Since the directivity of the first optical circulator 201 is assumed to be 60 dB in this embodiment, an optical signal of about −60 dBm sneaks into the upward optical signal receiver 117. Thus, the power of upward optical signals of wavelength λ₂ input to the upward optical signal receiver 117 becomes −15 dBm. Besides, the difference between the wavelength λ₁ (frequency f₁) and the wavelength λ₂ (frequency f₂) is about 3.2 nm (frequency difference: 400 GHz), and beat/noise components produced by interference in the two wavelengths λ₁ and λ₂ are present outside the 8 GHz band of the upward optical signal receiver 117. Thus, the upward optical signal receiver 117 is free from the influence of coherent crosstalk. In addition, there is a gap of more than 40 dB between the signal levels of the input and output signals, and therefore a problem of power crosstalk is also insignificant.

Similarly, there is no problem about the case where output signals from the upward optical signal transmitter 116 leak in the downward optical signal receiver 115 through the second optical circulator 202.

On the other hand, output signals from the upward optical signal transmitter 116 leak in the downward optical signal transmitter 111 through the first optical circulator 201. However, since the first optical circulator 201 is provided with an isolation of 40 dB, the power of the leakage signals is less than −54 dBm, thus having little influence.

In like wise, there is no problem about the case where output signals from the downward optical signal transmitter 111 leak in the upward optical signal transmitter 116 through the second optical circulator 202.

Moreover, transmission optical power is set lower than the induced Brilloum scattering threshold, thus causing no influence of the induced Brillouin scattering. Consequently, in the bidirectional optical transmission system 200 according to the second embodiment of the present invention, the bidirectional optical transmission of 10 Gbps can be realized.

Third Embodiment

FIG. 6 is a diagram schematically showing the configuration of a bidirectional optical transmission system according to the third embodiment of the present invention. In FIG. 6, the same parts as shown in FIG. 1 are designated by similar numerals, and may not require any further explanation. Referring to FIG. 6, the bidirectional optical transmission system 300 comprises a downward optical signal transmitter 111, a first upward/downward signal separating optical interleaver (hereinafter referred to as first optical interleaver) 301, an optical fiber transmission line 113, a second upward/downward signal separating optical interleaver (hereinafter referred to as second optical interleaver) 302, a downward optical signal receiver 115, an upward optical signal transmitter 116, and an upward optical signal receiver 117. The downward optical signal receiver 115 and upward optical signal receiver 117 receive downward and upward optical signals sent from the downward optical signal transmitter 111 and upward optical signal transmitter 116, respectively, via the first optical interleaver 301, optical fiber transmission line 113, and second optical interleaver 302.

In the bidirectional optical transmission system 300 of the third embodiment, both upward optical signals and downward optical signals are transmitted at a rate of 10 Gbps. The wavelength λ₁ of the downward optical signal is 1552. 52 nm (frequency f₁: 193. 10 THz), while the wavelength λ₂ of the upward optical signal is 1555. 75 nm (frequency f₂: 192.70 THz). Besides, output power of the optical transmitters 111 and 116 is 0 dBm, and the allowable reflected return light of them is 25 dB. The upward optical signal receiver 117 and downward optical signal receiver 115 are each assigned the frequency band of 8 GHz.

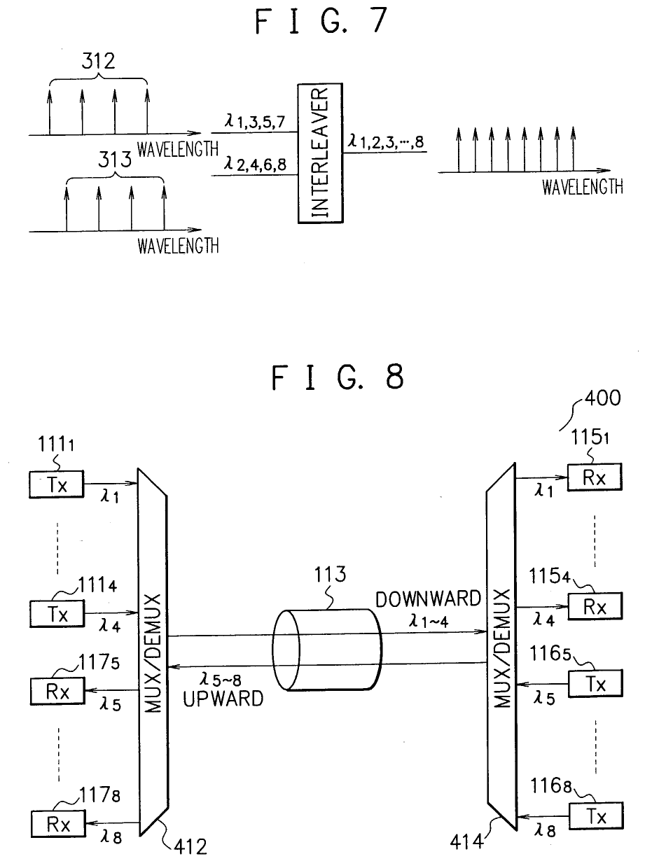

FIG. 7 is diagram illustrating the general configuration of an interleaver used in the third embodiment. The first and second optical interleavers 301 and 302 are used for making a separation between even and odd channels. More specifically, the first and second optical interleavers 301 and 302 interleave, for example, wavelength-division multiplexed (WDM) signals with wavelengths spaced 400 GHz apart so that the wavelengths of the signals are spaced 800 GHz apart, or wavelength-division multiplex a first wavelength group 312 and a second wavelength group 313, in which respective wavelengths are spaced 800 GHz apart, there being a gap of 400 GHz between the groups 312 and 313, so that wavelengths are spaced 400 GHz apart. The first and second optical interleavers 301 and 302 are characterized by having an insertion loss of 1 dB, isolation of 30 dB and directivity of 50 dB. Besides, the used frequency band is located at 1525 nm to 1565 nm. Transmission loss in the optical fiber transmission line 113 is 13 dB.

Output signals from the downward optical signal transmitter 111 leak in the upward optical signal receiver 117 through the first optical interleaver 301. Since the directivity of the first optical interleaver 301 is assumed to be 50 dB in this embodiment, an optical signal of about −50 dBm sneaks into the upward optical signal receiver 117. Thus, the power of upward optical signals of wavelength λ₂ input to the upward optical signal receiver 117 becomes −15 dBm. Besides, the difference between the wavelength λ₁ (frequency f₁) and the wavelength λ₂ (frequency f₂) is about 3.2 nm (frequency difference: 400 GHz), and beat/noise components produced by interference in the wavelengths λ₁ and λ₂ are present outside the 8 GHz band of the upward optical signal receiver 117. Thus, the upward optical signal receiver 117 is free from the influence of coherent crosstalk. In addition, there is a gap of more than 40 dB between the signal levels of the input and output signals, and therefore a problem of power crosstalk is also insignificant.

Similarly, there is no problem about the case where output signals from the upward optical signal transmitter 116 leak in the downward optical signal receiver 115 through the second optical interleaver 302.

On the other hand, output signals from the upward optical signal transmitter 116 leak in the downward optical signal transmitter 111 through the first optical interleaver 301. However, since the first optical circulator 201 is provided with an isolation of 30 dB, the power of the leakage signals is less than −44 dBm, thus having little influence.

In like wise, there is no problem about the case where output signals from the downward optical signal transmitter 111 leak in the upward optical signal transmitter 116 through the second optical interleaver 302.

Moreover, transmission optical power is set lower than the induced Brillouin scattering threshold, thus causing no influence of the induced Brilloum scattering. Consequently, in the bidirectional optical transmission system 300 according to the third embodiment of the present invention, the bidirectional optical transmission of 10 Gbps can be realized.

Fourth Embodiment

FIG. 8 is a diagram schematically showing the configuration of a bidirectional optical transmission system according to the fourth embodiment of the present invention. In FIG. 8, the same parts as shown in FIG. 1 are designated by similar numerals, and may not require any further explanation. Referring to FIG. 8, the bidirectional optical transmission system 400 comprises first to fourth downward optical signal transmitters 111₁ to 111₄, a first upward/downward signal separating multiplexer—demultiplexer (hereinafter referred to as first MUX/DEMUX) 412, an optical fiber transmission line 113, a second upward/downward signal separating multiplexer demultiplexer (hereinafter referred to as second MUX/DEMUX) 414, first to fourth downward optical signal receivers 115₁ to 115₄, fifth to eighth upward optical signal transmitters 116₅ to 116₈, and fifth to eighth upward optical signal receivers 117₅ to 117₈. The first to fourth downward optical signal receivers 115₁ to 115₄ receive downward optical signals of wavelengths λ₁ to λ₄ sent from the first to fourth downward optical signal transmitters 111₁ to 111₄, respectively, via the first MUX/DEMUX 412, optical fiber transmission line 113, and second MUX/DEMUX 414. On the other hand, the fifth to eighth upward optical signal receivers 117₅ to 117₈ receive upward optical signals of wavelengths λ₅ to λ₈ sent from the fifth to eighth upward optical signal transmitters 116₅ to 116₈, respectively, via the second MUX/DEMUX 414, optical fiber transmission line 113, and first MUX/DEMUX 412.

In the bidirectional optical transmission system 400 of the fourth embodiment, both upward optical signals and downward optical signals are transmitted at a rate of 10 Gbps using four wavelengths. In other words, the bidirectional optical transmission system 400 is provided with a transmission capacity of 40 Gbps for respective upward or uplink transmission and downward or downlink transmission. The wavelengths for downward transmission include wavelengths λ₁ to λ₄: λ₁ is 1536. 61 nm (frequency f₁: 195. 10 THz); λ₂ is 1539. 77 nm (frequency f₂: 194. 70 THz); λ₃ is 1542. 94 nm (frequency f₃: 194. 30 THz); and λ₄ is 1546. 12 nm (frequency f₄: 193. 90 THz). The wavelengths for upward transmission include wavelengths λ₅ to λ₈: λ₅ is 1549. 32 nm (frequency f₅: 193. 50 THz); λ₆ is 1552. 52 nm (frequency f₆: 193. 10 THz); λ₇ is 1555. 75 nm (frequency f₇: 192. 70 THz); and λ₈ is 1558. 98 nm (frequency f₈: 192. 30 THz).

Besides, output power of the first to eighth optical transmitters 111₁ to 111₄ and 116₅ to 116₈ is 0 dBm, and the allowable reflected return light of them is 25 dB. The fifth to eighth upward optical signal receivers 117₅ to 117₈ and first to fourth downward optical signal receivers 115₁ to 115₄ are each assigned the frequency band of 8 GHz. The first and second MUX/DEMUXs 412 and 414 are characterized by having an insertion loss of 4 dB, inter-channel isolation of 35 dB, directivity of 55 dB, and a pass band of 0.5 nm for each channel. Transmission loss in the optical fiber transmission line 113 is 6 dB.

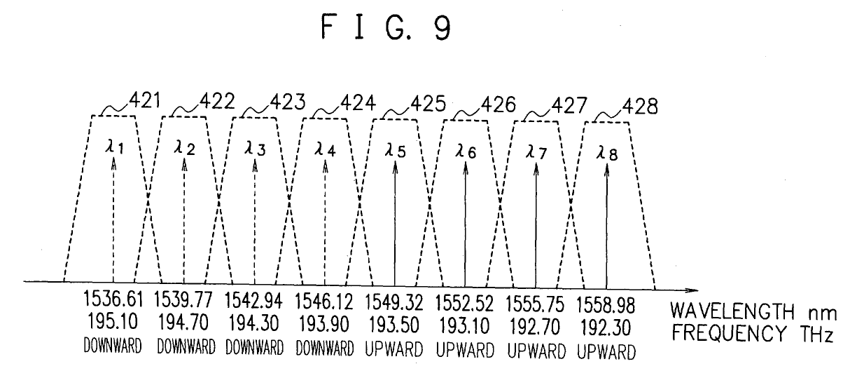

FIG. 9 is a diagram illustrating relationships between transparency characteristics of the first and second MUX/DEMUXs 412 and 414 and the respective wavelengths of optical signals. The first and second MUX/DEMUXs 412 and 414 have the same transparency characteristics. In FIG. 9, the transparency characteristic regarding wavelength λ₁ is indicated by dotted line 421 and that regarding wavelength λ₂ is indicated by dotted line 422. In like fashion, the transparency characteristics regarding wavelengths λ₃ to λ₈ are indicated by dotted lines 423 to 428, respectively.

Output signals from the first to fourth downward optical signal transmitters 111₁ to 111₄ leak in the fifth to eighth upward optical signal receivers 117₅ to 117₈, respectively, through the first MUX/DEMUX 412. Since the directivity of the first MUX/DEMUX 412 is assumed to be 55 dB in this embodiment, optical signals of about −49 dBm in total for four wavelengths sneaks into the fifth to eighth upward optical signal receivers 117₅ to 117₈. Thus, the power of upward optical signals (wavelength λ₅ to λ₈) input to the fifth to eighth upward optical signal receivers 117₅ to 117₈ becomes −14 dBm.

To take the fifth upward optical signal receiver 117₅ as an example, the fifth upward optical signal receiver 117₅ receives an optical signal of the wavelength λ₅ with a power of −14 dB from the fifth upward optical signal transmitter 116₅. Optical signals of about −49 dBm in total leak in the fifth upward optical signal receiver 117₅ from the output of the first to fourth downward optical signal transmitters 111₁ to 111₄. Besides, the difference between the wavelength λ₅ (frequency f₅) of upward optical signals input to the fifth upward optical signal receiver 117₅ and the wavelength λ₁ (frequency f₁) of downward optical signals output from the first downward optical signal transmitter 111₁ is about 12.7 nm (frequency difference: 1.6 THz), and beat/noise components produced by interference in the wavelengths λ₁ and λ₅ are present outside the 8 GHz band of the fifth upward optical signal receiver 117₅. Thus, the fifth upward optical signal receiver 117₅ is free from the influence of coherent crosstalk. In addition, there is a gap of more than 40 dB between the signal levels of the input and output signals, and therefore a problem of power crosstalk is also insignificant. Much the same is true on the wavelengths λ₂ and λ₅, wavelengths λ₃ and λ₅, and wavelengths λ₄ and λ₅. The difference between the wavelengths λ₂ and λ₅ is 9.6 nm (frequency difference: 1.2 THz), and beat/noise components produced by interference in the wavelengths λ₂ and λ₅ are present outside the 8 GHz band of the fifth upward optical signal receiver 117₅. The difference between the wavelengths λ₃ and λ₅ is 6.4 nm (frequency difference: 800 GHz), and beat/noise components produced by interference in the wavelengths λ₃ and λ₅ are present outside the 8 GHz band of the fifth upward optical signal receiver 117₅. The difference between the wavelengths λ₄ and λ₅ is 3.2 nm (frequency difference: 400 GHz), and beat/noise components produced by interference in the wavelengths λ₄ and λ₅ are present outside the 8 GHz band of the fifth upward optical signal receiver 117₅. Thus, the fifth upward optical signal receiver 117₅ is free from the influence of coherent crosstalk. In addition, there is a gap of more than 40 dB between the signal levels of the input and output signals, and therefore a problem of power crosstalk is also insignificant. The upward optical signal receivers other than the fifth upward optical signal receiver 117₅ are also undisturbed by the leakage signals from the output of the first to fourth downward optical signal transmitters 111₁ to 111₄.

Similarly, there is no problem about the case where output signals from the fifth to eighth upward optical signal transmitters 116₅ to 116₈ leak in the first to fourth downward optical signal receivers 115₁ to 115₄ through the second MUX/DEMUX 414.

On the other hand, output signals from the fifth to eighth upward optical signal transmitters 116₅ to 116₈ leak in the first to fourth downward optical signal transmitters 111₁ to 111₄ through the first MUX/DEMUX 412. However, since the first MUX/DEMUX 412 is provided with an isolation of 35 dB, the power of the leakage signals in total for the four wavelengths λ₅ and λ₈ is less than −39 dBm, thus having little influence.

In like wise, there is no problem about the case where output signals from the first to fourth downward optical signal transmitters 111₁ to 111₄ leak in the fifth to eighth upward optical signal transmitters 116₅ to 116₈ through the second MUX/DEMUX 414.

Moreover, transmission optical power is set lower than the induced Brilloum scattering threshold, thus causing no influence of the induced Brilloum scattering. Consequently, in the bidirectional optical transmission system 400 according to the fourth embodiment of the present invention, the bidirectional optical transmission of 10 Gbps by four wavelengths, that is, the bidirectional optical transmission of 40 Gbps can be realized.

Fifth Embodiment

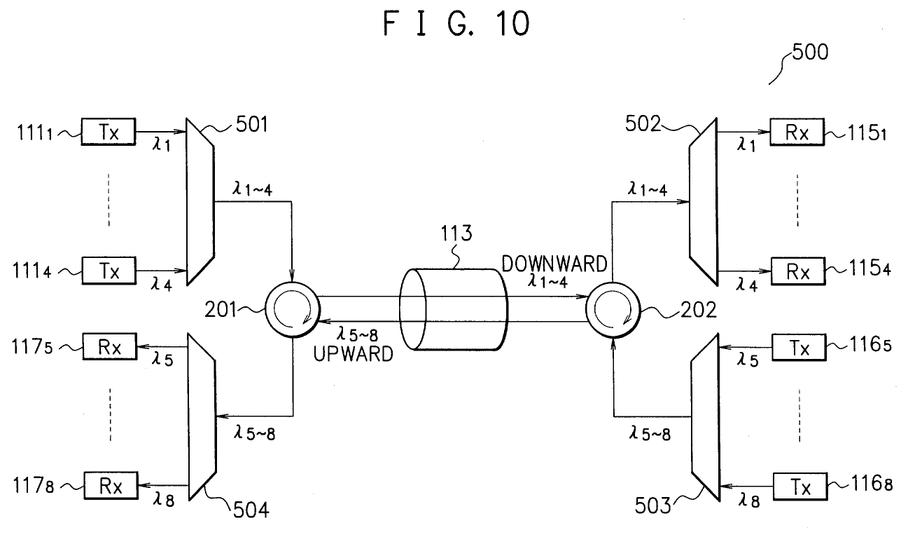

FIG. 10 is a diagram schematically showing the configuration of a bidirectional optical transmission system according to the fifth embodiment of the present invention. In FIG. 10, the same parts as shown in FIGS. 1, 4 and 8 are designated by similar numerals, and may not require any further explanation. Referring to FIG. 10, the bidirectional optical transmission system 500 comprises first to fourth downward optical signal transmitters 111₁ to 111₄, a downward signal multiplexer 501, a first optical circulator 201, an optical fiber transmission line 113, a second optical circulator 202, a downward signal demultiplexer 502, first to fourth downward optical signal receivers 115₁ to 115₄, fifth to eighth upward optical signal transmitters 116₅ to 116₈, an upward signal multiplexer 503, an upward signal demultiplexer 504, and fifth to eighth upward optical signal receivers 117₅ to 117₈.

The downward signal multiplexer 501 multiplexes downward optical signals of wavelengths λ₁ to λ₄ sent from the first to fourth downward optical signal transmitters 111₁ to 111₄. The downward signal demultiplexer 502 receives the downward optical signals of wavelengths λ₁ to λ₄ multiplexed by the downward signal multiplexer 501 via the first optical circulator 201, optical fiber transmission line 113 and second optical circulator 202 to demultiplex the signals. The downward optical signals of wavelengths λ₁ to λ₄ demultiplexed by the downward signal demultiplexer 502 are sent to the first to fourth downward optical signal receivers 115₁ to 115₄.

The upward signal multiplexer 503 multiplexes upward optical signals of wavelengths λ₅ to λ₈ sent from the fifth to eighth upward optical signal transmitters 116₅ to 116₈. The upward signal demultiplexer 504 receives the upward optical signals of wavelengths λ₅ to λ₈ multiplexed by the upward signal multiplexer 503 via the second optical circulator 202, optical fiber transmission line 113 and first optical circulator 201 to demultiplex the signals. The upward optical signals of wavelengths λ₅ to λ₈ demultiplexed by the upward signal demultiplexer 504 are sent to the fifth to eighth upward optical signal receivers 117₅ to 117₈.

In the bidirectional optical transmission system 500 of the fifth embodiment, both upward optical signals and downward optical signals are transmitted at a rate of 10 Gbps using four wavelengths. In other words, the bidirectional optical transmission system 500 is provided with a transmission capacity of 40 Gbps for respective upward transmission and downward transmission. The wavelengths for downward transmission include wavelengths λ₁ to λ₄, while the wavelengths for upward transmission include wavelengths λ₅ to λ₈. These wavelengths λ₁ to λ₈ are the same as those described previously in the fourth embodiment.

Besides, output power of the first to eighth optical transmitters 111₁ to 111₄ and 116₅ to 116₈ is 0 dBm, and the allowable reflected return light of them is 25 dB. The fifth to eighth upward optical signal receivers 117₅ to 117₈ and first to fourth downward optical signal receivers 115₁ to 115₄ are each assigned the frequency band of 8 GHz. The characteristics of the first and second optical circulators 201 and 202 are similar to those described in the second embodiment.

Relationships between the respective wavelengths of optical signals and transparency characteristics of the downward signal multiplexer 501, downward signal demultiplexer 502, upward signal multiplexer 503, and upward signal demultiplexer 504 are the same as those described in the fourth embodiment in connection with FIG. 9. The multiplexers and demultiplexers 501, 502, 503, and 504 are characterized by having an insertion loss of 4 dB, inter-channel isolation of 35 dB, directivity of 55 dB, and a pass band of 0.5 nm for each channel. Transmission loss in the optical fiber transmission line 113 is 6 dB.

Output signals from the first to fourth downward optical signal transmitters 111₁ to 111₄ leak in the fifth to eighth upward optical signal receivers 117₅ to 117₈, respectively, through the first optical circulator 201 and upward signal demultiplexer 504. Since the directivity of the first optical circulator 201 is assumed to be 60 dB and the inter-channel isolation of the upward signal demultiplexer 504 is assumed to be 35 dB in this embodiment, optical signals of about −89 dBm in total for four wavelengths sneaks into the fifth to eighth upward optical signal receivers 117₅ to 117₈. Thus, the power of upward optical signals (wavelength λ₅ to λ₈) input to the fifth to eighth upward optical signal receivers 117₅ to 117₈ becomes −16 dBm.

To take the fifth upward optical signal receiver 117₅ as an example, the fifth upward optical signal receiver 117₅ receives an optical signal of the wavelength λ₅ with a power of −16 dB from the fifth upward optical signal transmitter 116₅. Optical signals of about −89 dBm in total leak in the fifth upward optical signal receiver 117₅ from the output of the first to fourth downward optical signal transmitters 111₁ to 111₄. Besides, the difference between the wavelength λ₅ (frequency f₅) of upward optical signals input to the fifth upward optical signal receiver 117₅ and the wavelength λ₁ (frequency fi) of downward optical signals output from the first downward optical signal transmitter 111₁ is about 12.7 nm (frequency difference: 1.6 THz), and beat/noise components produced by interference in the wavelengths λ₁ and λ₅ are present outside the 8 GHz band of the fifth upward optical signal receiver 117₅. Thus, the fifth upward optical signal receiver 117₅ is free from the influence of coherent crosstalk. In addition, there is a gap of more than 80 dB between the signal levels of the input and output signals, and therefore a problem of power crosstalk is also insignificant. Much the same is true on the wavelengths λ₂ and λ₅, wavelengths λ₃ and λ₅, and wavelengths λ₄ and λ₅. The difference between the wavelengths λ₂ and λ₅ is 9.6 nm (frequency difference: 1.2 THz), and beat/noise components produced by interference in the wavelengths λ₂ and λ₅ are present outside the 8 GHz band of the fifth upward optical signal receiver 117₅. The difference between the wavelengths λ₃ and λ₅ is 6.4 nm (frequency difference: 800 GHz), and beat/noise components produced by interference in the wavelengths λ₃ and λ₅ are present outside the 8 GHz band of the fifth upward optical signal receiver 117₅. The difference between the wavelengths λ₄ and λ₅ is 3.2 nm (frequency difference: 400 GHz), and beat/noise components produced by interference in the wavelengths λ₄ and λ₅ are present outside the 8 GHz band of the fifth upward optical signal receiver 117₅. Thus, the fifth upward optical signal receiver 117₅ is free from the influence of coherent crosstalk. In addition, there is a gap of more than 40 dB between the signal levels of the input and output signals, and therefore a problem of power crosstalk is also insignificant. The upward optical signal receivers other than the fifth upward optical signal receiver 117₅ are also undisturbed by the leakage signals from the output of the first to fourth downward optical signal transmitters 111₁ to 111₄.

Similarly, there is no problem about the case where output signals from the fifth to eighth upward optical signal transmitters 116₅ to 116₈ leak in the first to fourth downward optical signal receivers 115₁ to 115₄ through the second optical circulator 202 and downward signal demultiplexer 502.

On the other hand, output signals from the fifth to eighth upward optical signal transmitters 116₅ to 116₈ leak in the first to fourth downward optical signal transmitters 111₁ to 111₄ through the first optical circulator 201 and downward signal multiplexer 501. However, since the first optical circulator 201 and downward signal multiplexer 501 are provided with isolations of 40 dB and 35 dB, respectively, the power of the leakage signals in total for the four wavelengths λ₅ and λ₈ is less than −80 dBm, thus having little influence.

In like wise, there is no problem about the case where output signals from the first to fourth downward optical signal transmitters 111₁ to 111₄ leak in the fifth to eighth upward optical signal transmitters 116₅ to 116₈ through the second optical circulator 202 and upward signal multiplexer 503.

Moreover, transmission optical power is set lower than the induced Brilloum scattering threshold, thus causing no influence of the induced Brillouin scattering. Consequently, in the bidirectional optical transmission system 500 according to the fifth embodiment of the present invention, the bidirectional optical transmission of 10 Gbps by four wavelengths, that is, the bidirectional optical transmission of 40 Gbps can be realized.

Sixth Embodiment

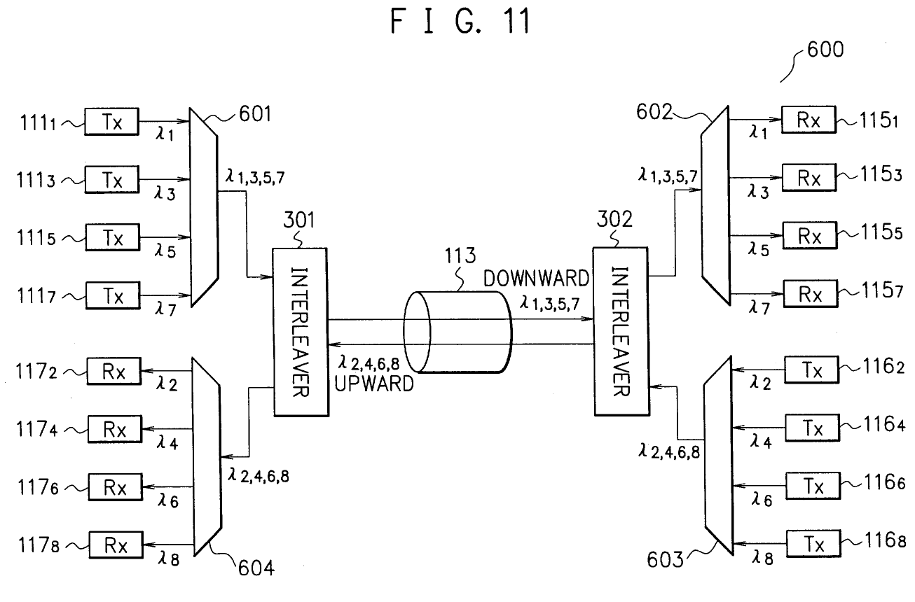

FIG. 11 is a diagram schematically showing the configuration of a bidirectional optical transmission system according to the sixth embodiment of the present invention. In FIG. 11, the same parts as shown in FIGS. 6 and 10 are designated by similar numerals, and may not require any further explanation. Referring to FIG. 11, the bidirectional optical transmission system 600 comprises first, third, fifth, and seventh downward optical signal transmitters 111₁, 111₃, 111₅ and 111₇, a downward signal multiplexer 601, a first optical interleaver 301, an optical fiber transmission line 113, a second optical interleaver 302, a downward signal demultiplexer 602, first, third, fifth, and seventh downward optical signal receivers 115₁, 115₃, 115₅ and 115₇, second, fourth, sixth and eighth upward optical signal transmitters 116₂, 116₄, 116₆ and 116₈, an upward signal multiplexer 603, an upward signal demultiplexer 604, and second, fourth, sixth and eighth upward optical signal receivers 117₂, 117₄, 117₆ and 117₈.

The downward signal multiplexer 601 multiplexes downward optical signals of odd number wavelengths λ₁, λ₃, λ₅ and λ₇ sent from the first, third, fifth, and seventh downward optical signal transmitters 111₁, 111₃, 111₅ and 111₇. The first optical interleaver 301 for making a separation between even and odd channels inputs the downward optical signals of odd number wavelengths multiplexed by the downward signal multiplexer 601 in its odd port (I/O port for odd number wavelength signals), and outputs the signals from its common port (I/O port for both odd number and even number wavelength signals). The second optical interleaver 302 inputs the downward optical signals sent from the first optical interleaver 301 via the optical fiber transmission line 113 in its common port, and outputs the signals from its odd port. The downward signal demultiplexer 602 receives the downward optical signals output from the second optical interleaver 302 to demultiplex the signals. The downward optical signals of odd number wavelengths λ₁, λ₃, λ₅ and λ₇ demultiplexed by the downward signal demultiplexer 602 are sent to the first, third, fifth, and seventh downward optical signal receivers 115₁, 115₃, 115₅ and 115₇.

The upward signal multiplexer 603 multiplexes upward optical signals of even number wavelengths λ₂, λ₄, λ₆ and λ₈ sent from the second, fourth, sixth and eighth upward optical signal transmitters 116₂, 116₄, 116₆ and 116₈. The second optical interleaver 302 inputs the upward optical signals of even number wavelengths multiplexed by the upward signal multiplexer 603 in its even port (I/O port for even number wavelength signals), and outputs the signals from the common port. The first optical interleaver 301 inputs the upward optical signals sent from the second optical interleaver 302 via the optical fiber transmission line 113 in the common port, and outputs the signals from its even port. The upward signal demultiplexer 604 receives the upward optical signals output from the first optical interleaver 301 to demultiplex the signals. The upward optical signals of even number wavelengths λ₂, λ₄, λ₆ and λ₈ demultiplexed by the upward signal demultiplexer 604 are sent to the second, fourth, sixth and eighth upward optical signal receivers 117₂, 117₄, 117₆ and 117₈.

In the bidirectional optical transmission system 600 of the sixth embodiment, both upward optical signals and downward optical signals are transmitted at a rate of 10 Gbps using four wavelengths. In other words, the bidirectional optical transmission system 600 is provided with a transmission capacity of 40 Gbps for respective upward transmission and downward transmission. The wavelengths for downward transmission include wavelengths λ₁, λ₃, λ₅ and λ₇: λ₁ is 1536. 61 nm (frequency f₁: 195. 10 THz); λ₃ is 1542. 94 nm (frequency f₃: 194. 30 THz); λ₅ is 1549. 32 nm (frequency f₅: 193. 50 THz); and λ₇ is 1555. 75 nm (frequency f₇: 192. 70 THz). The wavelengths for upward transmission include wavelengths X 2, λ₄, λ₆ and λ₈: λ₂ is 1539. 77 nm (frequency f₂: 194. 70 THz); λ₄ is 1546. 12 nm (frequency f₄: 193. 90 THz); λ₆ is 1552. 52 nm (frequency f₆: 193. 10 THz); and λ₈ is 1558. 98 nm (frequency f₈: 192. 30 THz).

Besides, output power of the first to eighth optical transmitters 111₁, 111₃, 115₁, 111₇, 116₂, 116₄, 116₆ and 116₈ is 0 dBm, and the allowable reflected return light of them is 25 dB. The second, fourth, sixth and eighth upward optical signal receivers 117₂, 117₄, 117₆ and 117₈ and first, third, fifth, and seventh downward optical signal receivers 115₁, 115₃, 115₅ and 115₇ are each assigned the frequency band of 8 GHz. The characteristics of the first and second optical interleavers 301 and 302 are similar to those described in the third embodiment.

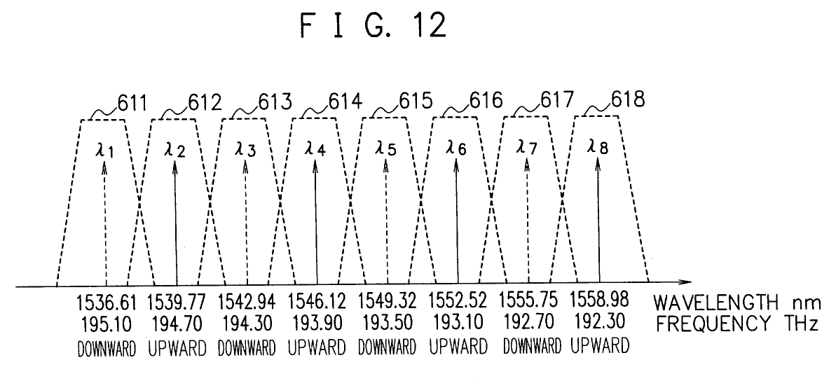

FIG. 12 is a diagram illustrating relationships between the respective wavelengths of optical signals and transparency characteristics of the downward signal multiplexer 601, downward signal demultiplexer 602, upward signal multiplexer 603, and upward signal demultiplexer 604. The downward signal multiplexer 601 and downward signal demultiplexer 602 have the same transparency characteristics. In FIG. 9, the transparency characteristic regarding wavelength λ₁ is indicated by dotted line 611, and that regarding wavelength λ₃ is indicated by dotted line 613. In like fashion, the transparency characteristics regarding wavelengths λ₅ and λ₇ are indicated by dotted lines 615 and 617, respectively. On the other hand, the upward signal multiplexer 603 and upward signal demultiplexer 604 have the same transparency characteristics, and in FIG. 9, the transparency characteristics regarding wavelength λ₂, λ₄, λ₆ and λ₈ are indicated by dotted lines 612, 614, 616 and 618, respectively.

As the characteristics of the multiplexers and demultiplexers 601, 602, 603 and 604, insertion loss is 4 dB, the inter-channel isolation of channels with a space of 80 GHz between them is 35 dB, isolation for wavelength spaced 400 GHz apart from a transparency channel is 25 dB, directivity is 55 dB, and a pass band of each channel is 0.5 nm. Transmission loss in the optical fiber transmission line 113 is 6 dB.

Output signals from the first, third, fifth, and seventh downward optical signal transmitters 111₁, 111₃, 111₅ and 111₇ leak in the second, fourth, sixth and eighth upward optical signal receivers 117₂, 117₄, 117₆ and 117₈ through the first optical interleaver 301 and upward signal demultiplexer 604, respectively. Since the directivity of the first optical interleaver 301 is assumed to be 50 dB and the inter-channel isolation of the upward signal demultiplexer 604 is assumed to be 35 dB in this embodiment, optical signals of about −79 dBm in total for four wavelengths sneaks into the second, fourth, sixth and eighth upward optical signal receivers 117₂, 117₄, 117₆ and 117₈. Thus, the power of upward optical signals input to the second, fourth, sixth and eighth upward optical signal receivers 117₂, 117₄, 117₆ and 117₈ becomes −16 dBm.

To take the second upward optical signal receiver 117₂ as an example, the second upward optical signal receiver 117₂ receives an optical signal of the wavelength λ₂ with a power of −16 dB from the second upward optical signal transmitter 116₂. Optical signals of about −79 dBm in total leak in the second upward optical signal receiver 117₂ from the output of the first, third, fifth, and seventh downward optical signal transmitters 111₁, 111₃, 111₅ and 111₇. Besides, the difference between the wavelength λ₂ (frequency f₂) of upward optical signals input to the second upward optical signal receiver 117₂ and the wavelength λ₁ (frequency f₁) of downward optical signals output from the first downward optical signal transmitter 111₁ is about 3.2 nm (frequency difference: 400 GHz), and beat/noise components produced by interference in the wavelengths λ₁ and λ₂ are present outside the 8 GHz band of the second upward optical signal receiver 117₂. Thus, the second upward optical signal receiver 117₂ is free from the influence of coherent crosstalk. In addition, there is a gap of about 80 dB between the signal levels of the input and output signals, and therefore a problem of power crosstalk is also insignificant. Much the same is true on the wavelengths λ₃ and λ₂, wavelengths λ₅ and λ₂, and wavelengths λ₇ and λ₂. The difference between the wavelengths λ₃ and λ₂ is 3.2 nm (frequency difference: 400 GHz), and beat/noise components produced by interference in the wavelengths λ₃ and λ₂ are present outside the 8 GHz band of the second upward optical signal receiver 117₂. The difference between the wavelengths λ₅ and λ₂ is 9.6 nm (frequency difference: 1.2 THz), and beat/noise components produced by interference in the wavelengths λ₅ and λ₂ are present outside the 8 GHz band of the second upward optical signal receiver 117₂. The difference between the wavelengths λ₇ and λ₂ is 16 nm (frequency difference: 2 THz), and beat/noise components produced by interference in the two wavelengths λ₇ and λ₂ are present outside the 8 GHz band of the second upward optical signal receiver 117₂. Thus, the second upward optical signal receiver 117₂ is free from the influence of coherent crosstalk. In addition, there is a gap of about 80 dB between the signal levels of the input and output signals, and therefore a problem of power crosstalk is also insignificant. The upward optical signal receivers other than the second upward optical signal receiver 117₂ are also undisturbed by the leakage signals from the output of the first, third, fifth, and seventh downward optical signal transmitters 111₁, 111₃, 111₅ and 111₇.

Similarly, there is no problem about the case where output signals from the second, fourth, sixth and eighth upward optical signal transmitters 116₂, 116₄, 116₆ and 116₈ leak in the first, third, fifth, and seventh downward optical signal receivers 115₁, 115₃, 115₅ and 115₇ through the second optical interleaver 302 and downward signal demultiplexer 602.

On the other hand, output signals from the second, fourth, sixth and eighth upward optical signal transmitters 116₂, 116₄, 116₆ and 116₈ leak in the first, third, fifth, and seventh downward optical signal transmitters 111₁, 111₃, 111₅ and 111₇ through the first optical interleaver 301 and downward signal multiplexer 601. However, since the first optical interleaver 301 and downward signal multiplexer 601 are provided with isolations of 40 dB and 25 dB, respectively, the power of the leakage signals in total for the four wavelengths λ₂, λ₄, λ₆, and λ₈ is less than −70 dBm, thus having little influence.

In like wise, there is no problem about the case where output signals from the first, third, fifth, and seventh downward optical signal transmitters 111₁, 111₃, 111₅ and 111₇ leak in the second, fourth, sixth and eighth upward optical signal transmitters 116₂, 116₄, 116₆ and 116₈ through the second optical interleaver 302 and upward signal multiplexer 603.

Moreover, transmission optical power is set lower than the induced Brilloum scattering threshold, thus causing no influence of the induced Brilloum scattering. Consequently, in the bidirectional optical transmission system 600 according to the sixth embodiment of the present invention, the bidirectional optical transmission of 10 Gbps by four wavelengths, that is, the bidirectional optical transmission of 40 Gbps can be realized.

Seventh Embodiment

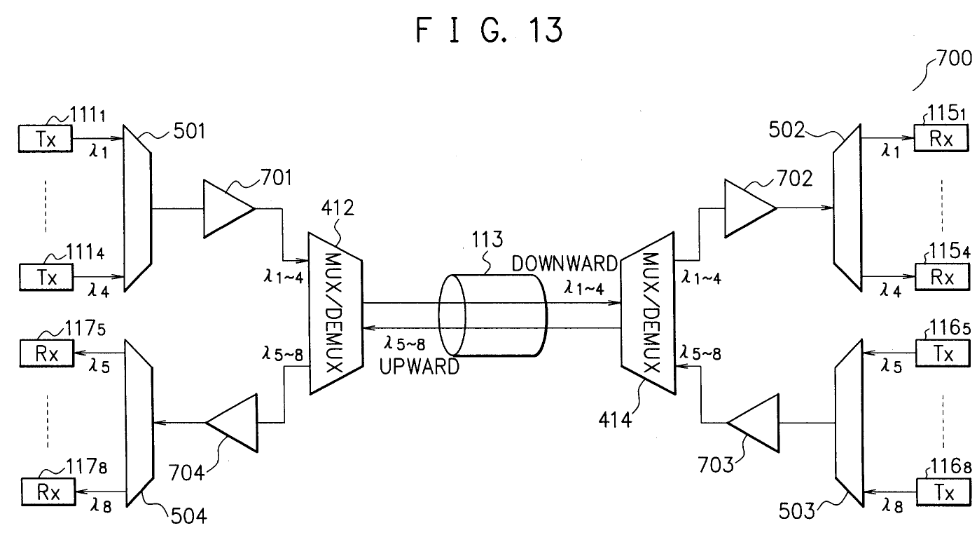

FIG. 13 is a diagram schematically showing the configuration of a bidirectional optical transmission system according to the seventh embodiment of the present invention. In FIG. 13, the same parts as shown in FIGS. 8 and 10 are designated by similar numerals, and may not require any further explanation. Referring to FIG. 13, the bidirectional optical transmission system 700 comprises first to fourth downward optical signal transmitters 111₁ to 111₄, a downward signal multiplexer 501, a downward signal amplifying erbium dope optical fiber amplifier (hereinafter referred to as downward signal EDFA) 701, a first MUX/DEMUX 412, an optical fiber transmission line 113, a second MUX/DEMUX 414, a downward signal EDFA 702, a downward signal demultiplexer 502, first to fourth downward optical signal receivers 115₁ to 115₄, fifth to eighth upward optical signal transmitters 116₅ to 116₈, an upward signal multiplexer 503, an upward signal amplifying erbium dope optical fiber amplifier (hereinafter referred to as upward signal EDFA) 703, an upward signal EDFA 704, an upward signal demultiplexer 504, and fifth to eighth upward optical signal receivers 117₅ to 117₈.

The downward signal multiplexer 501 multiplexes downward optical signals of wavelengths λ₁ to λ₄ sent from the first to fourth downward optical signal transmitters 111₁ to 111₄. The downward signal EDFA 701 amplifies the downward optical signals multiplexed by the downward signal multiplexer 501. The downward signal EDFA 702 receives the amplified optical signals output from the downward signal EDFA 701 via the first MUX/DEMUX 412, optical fiber transmission line 113 and second MUX/DEMUX 414 to amplify the downward optical signals. The downward signal demultiplexer 502 demultiplexes the downward optical signals amplified by the downward signal EDFA 702. The downward optical signals of wavelengths λ₁ to λ₄ demultiplexed by the downward signal demultiplexer 502 are sent to the first to fourth downward optical signal receivers 115₁ to 115₄.

The upward signal multiplexer 503 multiplexes upward optical signals of wavelengths λ₅ to λ₈ sent from the fifth to eighth upward optical signal transmitters 116₅ to 116₈. The upward signal EDFA 703 amplifies the upward, optical signals multiplexed by the upward signal multiplexer 503. The upward signal EDFA 704 receives the amplified optical signals output from the upward signal EDFA 703 via the second MUX/DEMUX 414, optical fiber transmission line 113 and first MUX/DEMUX 412 to amplify the upward optical signals. The upward signal demultiplexer 504 demultiplexes the upward optical signals amplified by the upward signal EDFA 704. The upward optical signals of wavelengths λ₅ to λ₈ demultiplexed by the upward signal demultiplexer 504 are sent to the fifth to eighth upward optical signal receivers 117₅ to 117₈.

In the bidirectional optical transmission system 700 of the seventh embodiment, both upward optical signals and downward optical signals are transmitted at a rate of 10 Gbps using four wavelengths. In other words, the bidirectional optical transmission system 700 is provided with a transmission capacity of 40 Gbps for respective upward transmission and downward transmission. The wavelengths for downward transmission include wavelengths λ₁ to λ₄, while the wavelengths for upward transmission include wavelengths λ₅ to λ₈. These wavelengths λ₁ to λ₈ are the same as those described previously in the fourth embodiment.

Besides, output power of the first to eighth optical transmitters 111₁ to 111₄ and 116₅ to 116₈ is 0 dBm, and the allowable reflected return light of them is 25 dB. The fifth to eighth upward optical signal receivers 117₅ to 117₈ and first to fourth downward optical signal receivers 115₁ to 115₄ are each assigned the frequency band of 8 GHz.

The first and second MUX/DEMUXs 412 and 414 are characterized by having an insertion loss of 2 dB, inter-channel isolation of 35 dB, and directivity of 55 dB, and a pass band of 10 nm for each channel.

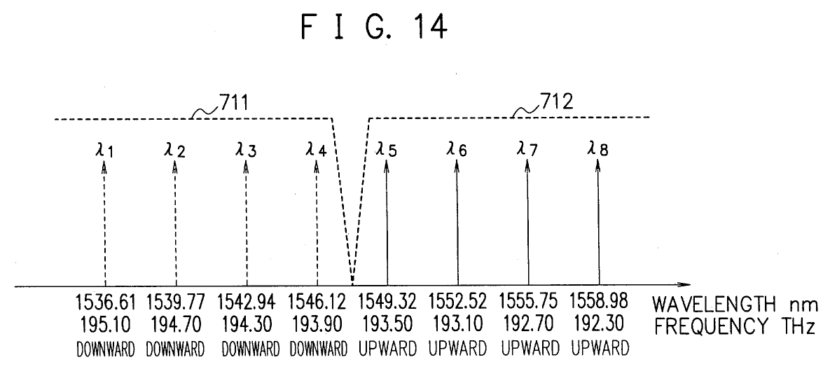

FIG. 14 is a diagram illustrating the allocation relationships between the respective wavelengths of optical signals and transparency characteristics of the first and second MUX/DEMUX 412 and 414. In FIG. 14, the transparency characteristic of the first MUX/DEMUX 412 is indicated by dotted line 711 and that of the second MUX/DEMUX 414 is indicated by dotted line 122.

Relationships between the respective wavelengths of optical signals and transparency characteristics of the downward signal multiplexer 501, downward signal demultiplexer 502, upward signal multiplexer 503, and upward signal demultiplexer 504 are the same as those described in the fourth embodiment in connection with FIG. 9. The multiplexers and demultiplexers 501, 502, 503, and 504 are characterized by having an insertion loss of 4 dB, inter-channel isolation of 35 dB, directivity of 55 dB, and a pass band of 0.5 nm for each channel. Transmission loss in the optical fiber transmission line 113 is 27 dB.

The downward signal EDFA 701 and upward signal EDFA 703 produce a gain of 10 dB, in which saturation power is +8 dBm per wave. On the other hand, the downward signal EDFA 702 and upward signal EDFA 704 produce a gain of 15 dB, in which NF (Noise Figure) is 7 dB.

Output signals from the first to fourth downward optical signal transmitters 111₁ to 111₄ leak in the fifth to eighth upward optical signal receivers 117₅ to 117₈ through the first MUX/DEMUX 412 and upward signal demultiplexer 504. Since the directivity of the first MUX/DEMUX 412, inter-channel isolation of the upward signal demultiplexer 504, output power of the downward signal EDFA 701 and gain of the upward signal EDFA 704 are assumed to be 55 dB, 35 dB, +6 dBm and 15 dB, respectively, in this embodiment, optical signals of about −63 dBm in total for four wavelengths sneaks into the fifth to eighth upward optical signal receivers 117₅ to 117₈. Thus, the power of upward optical signals (wavelength λ₅ to λ₈) input to the fifth to eighth upward optical signal receivers 117₅ to 117₈ becomes −14 dBm.

To take the fifth upward optical signal receiver 117₅ as an example, the fifth upward optical signal receiver 117₅ receives an optical signal of the wavelength λ₅ with a power of −14 dB from the fifth upward optical signal transmitter 116₅. Optical signals of about −63 dBm in total leak in the fifth upward optical signal receiver 117₅ from the output of the first to fourth downward optical signal transmitters 111₁ to 111₄. Besides, the difference between the wavelength λ₅ (frequency f₅) of upward optical signals input to the fifth upward optical signal receiver 117₅ and the wavelength λ₁ (frequency f₁) of downward optical signals output from the first downward optical signal transmitter 111₁ is about 12.7 nm (frequency difference: 1.6 THz), and beat/noise components produced by interference in the wavelengths λ₁ and λ₅ are present outside the 8 GHz band of the fifth upward optical signal receiver 117₅. Thus, the fifth upward optical signal receiver 117₅ is free from the influence of coherent crosstalk. In addition, there is a gap of about 50 dB between the signal levels of the input and output signals, and therefore a problem of power crosstalk is also insignificant. Much the same is true on the wavelengths λ₂ and λ₅, wavelengths λ₃ and λ₅, and wavelengths λ₄ and λ₅, and the influence of coherent crosstalk as well as power crosstalk is negligible. The upward optical signal receivers other than the fifth upward optical signal receiver 117₅ are also undisturbed by the leakage signals from the output of the first to fourth downward optical signal transmitters 111₁ to 111₄.

Similarly, there is no problem about the case where output signals from the fifth to eighth upward optical signal transmitters 116₅ to 116₈ leak in the first to fourth downward optical signal receivers 115₁ to 115₄ through the second MUX/DEMUX 414 and downward signal demultiplexer 502.

Incidentally, although output signals from the fifth to eighth upward optical signal transmitters 116₅ to 116₈ leak in the downward signal EDFA 701 through the first MUX/DEMUX 412, the downward signal EDFA 701 is not disturbed by the influence of the leakage signals since the downward signal EDFA 701 is provided with a built-in isolator.

In like wise, although output signals from the first to fourth downward optical signal transmitters 111₁ to 111₄ leak in the upward signal EDFA 703 through the second MUX/DEMUX 414, the upward signal EDFA 703 is not disturbed by the leakage signals since the upward signal EDFA 703 is provided with a built-in isolator.

Moreover, transmission optical power is set lower than the induced Brilloum scattering threshold, thus causing no influence of the induced Brillouin scattering. Consequently, in the bidirectional optical transmission system 700 according to the seventh embodiment of the present invention, the bidirectional optical transmission of 10 Gbps by four wavelengths, that is, the long-distance bidirectional optical transmission of 40 Gbps allowing a span loss of more than 25 dB can be realized.

Eighth Embodiment

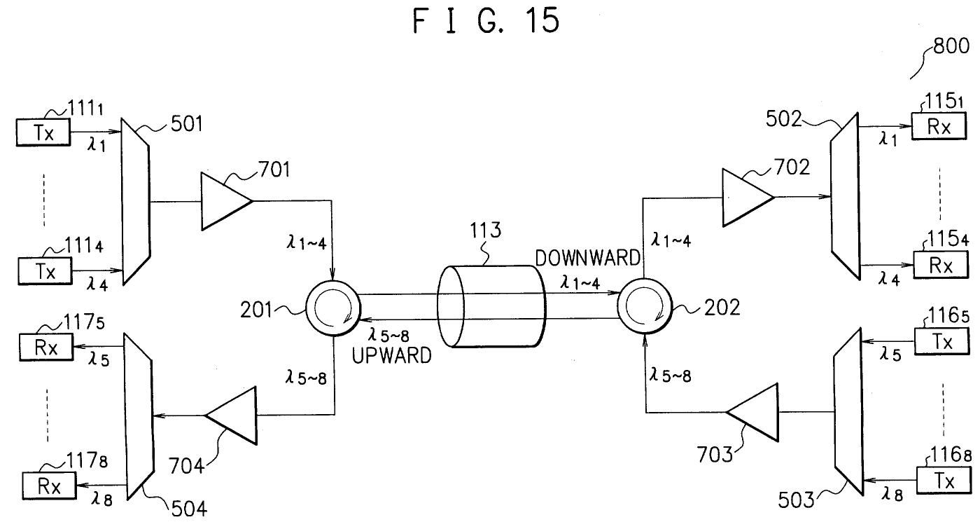

FIG. 15 is a diagram schematically showing the configuration of a bidirectional optical transmission system according to the eighth embodiment of the present invention. In FIG. 15, the same parts as shown in FIGS. 10 and 13 are designated by similar numerals, and may not require any further explanation. Referring to FIG. 15, the bidirectional optical transmission system 800 comprises first to fourth downward optical signal transmitters 111₁ to 111₄, a downward signal multiplexer 501, a downward signal EDFA 701, a first optical circulator 201, an optical fiber transmission line 113, a second optical circulator 202, a downward signal EDFA 702, a downward signal demultiplexer 502, first to fourth downward optical signal receivers 115₁ to 115₄, fifth to eighth upward optical signal transmitters 116₅ to 116₈, an upward signal multiplexer 503, an upward signal EDFA 703, an upward signal EDFA 704, an upward signal demultiplexer 504, and fifth to eighth upward optical signal receivers 117₅ to 117₈.

The downward signal multiplexer 501 multiplexes downward optical signals of wavelengths λ₁ to λ₄ sent from the first to fourth downward optical signal transmitters 111₁ to 111₄. The downward signal EDFA 701 amplifies the downward optical signals multiplexed by the downward signal multiplexer 501. The downward signal EDFA 702 receives the amplified optical signals output from the downward signal EDFA 701 via the first optical circulator 201, optical fiber transmission line 113 and second optical circulator 202 to amplify the downward optical signals. The downward signal demultiplexer 502 demultiplexes the downward optical signals amplified by the downward signal EDFA 702. The downward optical signals of wavelengths λ₁ to λ₄ demultiplexed by the downward signal demultiplexer 502 are sent to the first to fourth downward optical signal receivers 115₁ to 115₄.

The upward signal multiplexer 503 multiplexes upward optical signals of wavelengths λ₅ to λ₈ sent from the fifth to eighth upward optical signal transmitters 116₅ to 116₈. The upward signal EDFA 703 amplifies the upward optical signals multiplexed by the upward signal multiplexer 503. The upward signal EDFA 704 receives the amplified optical signals output from the upward signal EDFA 703 via the second optical circulator 202, optical fiber transmission line 113 and first optical circulator 201 to amplify the upward optical signals. The upward signal demultiplexer 504 demultiplexes the upward optical signals amplified by the upward signal EDFA 704. The upward optical signals of wavelengths λ₅ to λ₈ demultiplexed by the upward signal demultiplexer 504 are sent to the fifth to eighth upward optical signal receivers 117₅ to 117₈.

In the bidirectional optical transmission system 800 of the eighth embodiment, both upward optical signals and downward optical signals are transmitted at a rate of 10 Gbps using four wavelengths. In other words, the bidirectional optical transmission system 800 is provided with a transmission capacity of 40 Gbps for respective upward transmission and downward transmission. The wavelengths for downward transmission include wavelengths λ₁ to λ₄, while the wavelengths for upward transmission include wavelengths λ₅ to λ₈. These wavelengths λ₁ to λ₈ are the same as those described previously in the fourth embodiment.

Besides, output power of the first to eighth optical transmitters 111₁ to 111₄ and 116₅ to 116₈ is 0 dBm, and the allowable reflected return light of them is 25 dB. The fifth to eighth upward optical signal receivers 117₅ to 117₈ and first to fourth downward optical signal receivers 115₁ to 115₄ are each assigned the frequency band of 8 GHz. The characteristics of the first and second optical circulators 201 and 202 are similar to those described in the second embodiment.

Relationships between the respective wavelengths of optical signals and transparency characteristics of the downward signal multiplexer 501, downward signal demultiplexer 502, upward signal multiplexer 503, and upward signal demultiplexer 504 are the same as those described in the fourth embodiment in connection with FIG. 9. Additionally, the multiplexers and demultiplexers 501, 502, 503, and 504 have the same characteristics as those in the fifth embodiment. Transmission loss in the optical fiber transmission line 113 is 6 dB.

Relationships between the respective wavelengths of optical signals and transparency characteristics of the downward signal multiplexer 501, downward signal demultiplexer 502, upward signal multiplexer 503, and upward signal demultiplexer 504 are the same as those described in the fourth embodiment in connection with FIG. 9. The multiplexers and demultiplexers 501, 502, 503, and 504 are characterized by having an insertion loss of 4 dB, inter-channel isolation of 35 dB, directivity of 55 dB, and a pass band of 0.5 nm for each channel. Transmission loss in the optical fiber transmission line 113 is 27 dB.

The downward signal EDFAs 701 and 702 as well as the upward signal EDFAs 703 and 704 has the same characteristics as described previously in the seventh embodiment.

Output signals from the first to fourth downward optical signal transmitters 111₁ to 111₄ leak in the fifth to eighth upward optical signal receivers 117₅ to 117₈ through the first optical circulator 201 and upward signal demultiplexer 504. However, this does not become a problem as in the case of the fifth and seventh embodiments.

Similarly, there is no problem about the case where output signals from the fifth to eighth upward optical signal transmitters 116₅ to 116₈ leak in the first to fourth downward optical signal receivers 115₁ to 115₄ through the second optical circulator 202 and downward signal demultiplexer 502.

Further, although output signals from the fifth to eighth upward optical signal transmitters 116₅ to 116₈ leak in the downward signal EDFA 701 through the first optical circulator 201, the downward signal EDFA 701 is not disturbed by the leakage signals as in the case of the seventh embodiment.

In like wise, although output signals from the first to fourth downward optical signal transmitters 111₁ to 111₄ leak in the upward signal EDFA 703 through the second optical circulator 202, this does not become a problem as in the case of the seventh embodiment.

Furthermore, transmission optical power is set lower than the induced Brilloum scattering threshold, thus causing no influence of the induced Brilloum scattering. Consequently, in the bidirectional optical transmission system 800 according to the eighth embodiment of the present invention, the bidirectional optical transmission of 10 Gbps by four wavelengths, that is, the long-distance bidirectional optical transmission of 40 Gbps allowing a span loss of more than 25 dB can be realized.

Ninth Embodiment

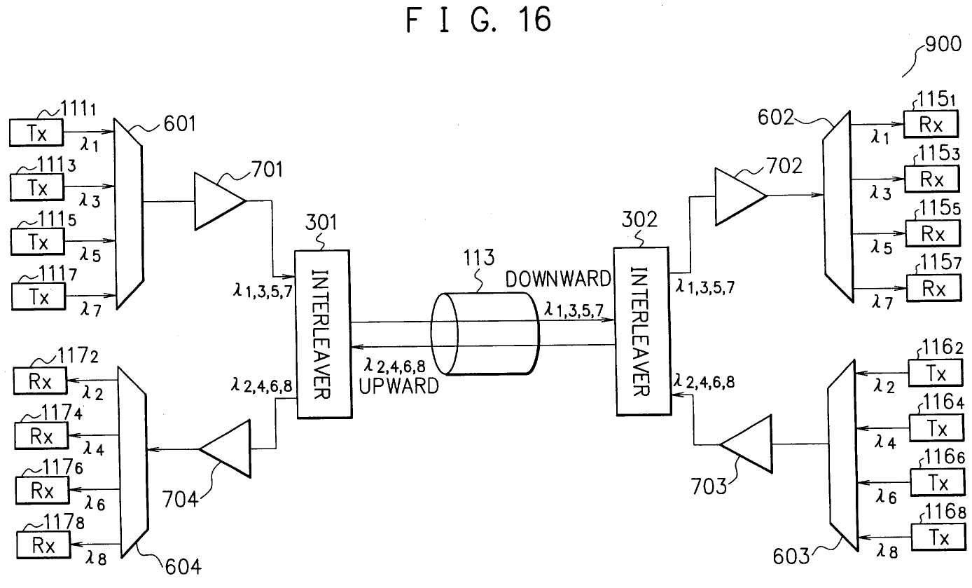

FIG. 16 is a diagram schematically showing the configuration of a bidirectional optical transmission system according to the ninth embodiment of the present invention. In FIG. 16, the same parts as shown in FIGS. 11 and 15 are designated by similar numerals, and may not require any further explanation. Referring to FIG. 16, the bidirectional optical transmission system 900 comprises first, third, fifth, and seventh downward optical signal transmitters 111₁, 111₃, 111₅ and 111₇, a downward signal multiplexer 601, a downward signal EDFA 701, a first optical interleaver 301, an optical fiber transmission line 113, a second optical interleaver 302, a downward signal EDFA 702, a downward signal demultiplexer 602, first, third, fifth, and seventh downward optical signal receivers 115₁, 115₃, 115₅ and 115₇, second, fourth, sixth and eighth upward optical signal transmitters 116₂, 116₄, 116₆ and 116₈, an upward signal multiplexer 603, an upward signal EDFA 703, an upward signal EDFA 704, an upward signal demultiplexer 604, and second, fourth, sixth and eighth upward optical signal receivers 117₂, 117₄, 117₆ and 117₈.

The downward signal multiplexer 601 multiplexes downward optical signals of odd number wavelengths λ₁, λ₃, λ₅ and λ₇ sent from the first, third, fifth, and seventh downward optical signal transmitters 111₁, 111₃, 111₅ and 111₇. The downward signal EDFA 701 amplifies the downward optical signals multiplexed by the downward signal multiplexer 601. The first optical interleaver 301 for making a separation between even and odd channels receives the downward optical signals of odd number wavelengths output from the downward signal EDFA 701, and outputs the signals from its odd port. The downward signal EDFA 702 receives the amplified optical signals via the first optical interleaver 301, optical fiber transmission line 113 and second optical interleaver 302 to amplify the downward optical signals. The downward signal demultiplexer 602 receives the downward optical signals amplified by the downward signal EDFA 702 to demultiplex the signals. The downward optical signals of odd number wavelengths λ₁, λ₃, λ₅ and λ₇ demultiplexed by the downward signal demultiplexer 602 are sent to the first, third, fifth, and seventh downward optical signal receivers 115₁, 115₃, 115₅ and 115₇.

The upward signal multiplexer 603 multiplexes upward optical signals of even number wavelengths λ₂, λ₄, λ₆ and λ₈ sent from the second, fourth, sixth and eighth upward optical signal transmitters 116₂, 116₄, 116₆ and 116₈. The upward signal EDFA 703 amplifies the upward optical signals multiplexed by the upward signal multiplexer 603. The second optical interleaver 302 for making a separation between even and odd channels receives the upward optical signals of even number wavelengths output from the upward signal EDFA 703, and outputs the signals from its even port. The upward signal EDFA 704 receives the amplified optical signals via the second optical interleaver 302, optical fiber transmission line 113 and first optical interleaver 301 to amplify the upward optical signals. The upward signal demultiplexer 604 receives the upward optical signals amplified by the upward signal EDFA 704 to demultiplex the signals. The upward optical signals of even number wavelengths λ₂, λ₄, λ₆ and λ₈ demultiplexed by the upward signal demultiplexer 604 are sent to the second, fourth, sixth and eighth upward optical signal receivers 117₂, 117₄, 117₆ and 117₈.

In the bidirectional optical transmission system 900 of the ninth embodiment, both upward optical signals and downward optical signals are transmitted at a rate of 10 Gbps using four wavelengths. In other words, the bidirectional optical transmission system 900 is provided with a transmission capacity of 40 Gbps for respective upward transmission and downward transmission. The wavelengths for downward transmission include wavelengths λ₁, λ₃, λ₅ and λ₇, while the wavelengths for upward transmission include wavelengths λ₂, λ₄, λ₆ and λ₈. These wavelengths λ₁ to λ₈ are the same as those described previously in the sixth embodiment Besides, output power of the first to eighth optical transmitters 111₁, 111₃, 115₁, 111₇, 116₂, 116₄, 116₆ and 116₈ is 0 dBm, and the allowable reflected return light of them is 25 dB. The second, fourth, sixth and eighth upward optical signal receivers 117₂, 117₄, 117₆ and 117₈ and first, third, fifth, and seventh downward optical signal receivers 115₁, 115₃, 115₅ and 115₇ are each assigned the frequency band of 8 GHz. The characteristics of the first and second optical interleavers 301 and 302 are similar to those described in the third embodiment.

Relationships between the respective wavelengths of optical signals and transparency characteristics of the downward signal multiplexer 601, downward signal demultiplexer 602, upward signal multiplexer 603, and upward signal demultiplexer 604 are the same as those described in the sixth embodiment in connection with FIG. 12. Additionally, the multiplexers and demultiplexers 601, 602, 603, and 604 have the same characteristics as those in the sixth embodiment. Transmission loss in the optical fiber transmission line 113 is 27 dB.

The downward signal EDFAs 701 and 702 as well as the upward signal EDFAs 703 and 704 has the same characteristics as described previously in the seventh embodiment.

Output signals from the first, third, fifth, and seventh downward optical signal transmitters 111₁, 111₃, 111₅ and 111₇ leak in the second, fourth, sixth and eighth upward optical signal receivers 117₂, 117₄, 117₆ and 117₈ through the first optical interleaver 301 and upward signal demultiplexer 604. However, neither coherent crosstalk nor power crosstalk presents a problem as in the case of the fifth and seventh embodiments.

Similarly, there is no problem about the case where output signals from the second, fourth, sixth and eighth upward optical signal transmitters 116₂, 116₄, 116₆ and 116₈ leak in the first, third, fifth, and seventh downward optical signal receivers 115₁, 115₃, 115₅ and 115₇ through the second optical interleaver 302 and downward signal demultiplexer 602.

Further, although output signals from the second, fourth, sixth and eighth upward optical signal transmitters 116₂, 116₄, 116₆ and 116₈ leak in the downward signal EDFA 701 through the first optical interleaver 301, the downward signal EDFA 701 does not suffer form the leakage signals as in the case of the seventh embodiment.

In like wise, although output signals from the first, third, fifth, and seventh downward optical signal transmitters 111₁, 111₃, 111₅ and 111₇ leak in the upward signal EDFA 703 through the second optical interleaver 302, this does not become a problem as in the case of the seventh embodiment.

Furthermore, transmission optical power is set lower than the induced Brilloum scattering threshold, thus causing no influence of the induced Brillouin scattering. Consequently, in the bidirectional optical transmission system 900 according to the ninth embodiment of the present invention, the bidirectional optical transmission of 10 Gbps by four wavelengths, that is, the long-distance bidirectional optical transmission of 40 Gbps allowing a span loss of more than 25 dB can be realized.

While preferred embodiments of the present invention have been described using specific terms, such description is for illustrative purposes only, and it is to be understood that changes and variations may be made without departing from the spirit or the scope of the present invention. For example, transmission rate is not limited to 10 Gbps as described in the above embodiments, and may be 12 Gbps or 40 Gbps. While four wavelengths are used for respective upward and downward transmissions in the above fourth to ninth embodiments, it is possible to use eight or sixteen wavelengths. Besides, wavelengths may be spaced 100 GHz apart or 50 GHz apart. Transmission rate may vary according to wavelengths. In addition, both C band and L band are available.

As set forth hereinabove, in accordance with the present invention, it is possible to avoid the influence of upward and downward leakage optical signals, thus realizing the single-fiber bidirectional optical transmission with large transmission capacity by using the WDM technique. Moreover, it is possible to realize the single-fiber bidirectional optical transmission, in which tolerable losses in the optical fiber, namely, transmission distance can be increased.

While the present invention has been described with reference to the particular illustrative embodiments, it is not to be restricted by the embodiments but only by the appended claims. It is to be appreciated that those skilled in the art can change or modify the embodiment without departing from the scope and spirit of the present invention.

What is claimed is:

1. An optical transmission system comprising:
an optical fiber;
a downward optical signal transmitter for sending downward optical signals at transmission power lower than an induced Brilloum scattering threshold;
a downward optical signal receiver for receiving the downward optical signals sent from the downward optical signal transmitter via the optical fiber;
an upward optical signal transmitter for sending upward optical signals at transmission power lower than the induced Brillouin scattering threshold; and
an upward optical signal receiver for receiving the upward optical signals sent from the upward optical signal transmitter via the optical fiber;
wherein the difference between the frequency of the upward optical signal sent from the upward optical signal transmitter and the frequency of the downward optical signal sent from the downward optical signal transmitter is greater than bandwidths assigned to the downward optical signal receiver and the upward optical signal receiver.

2. An optical transmission system comprising:
an optical fiber;
a plurality of downward optical signal transmitters each sending downward optical signals of a different frequency at transmission power lower than an induced Brilloum scattering threshold;
a plurality of downward optical signal receivers each receiving the downward optical signals sent from the respective downward optical signal transmitters via the optical fiber according to each frequency;
a plurality of upward optical signal transmitters each sending upward optical signals of a different frequency at transmission power lower than the induced Brilloum scattering threshold; and
a plurality of upward optical signal receivers each receiving the upward optical signals sent from the respective upward optical signal transmitters via the optical fiber according to each frequency;
wherein the differences between the respective frequencies of the upward optical signals sent from the upward optical signal transmitters and the respective frequencies of the downward optical signals sent from the downward optical signal transmitters are greater than bandwidths assigned to all the downward optical signal receivers and the upward optical signal receivers.

3. The optical transmission system claimed in claim 1, further comprising a plurality of optical multiplexer demultiplexers for making a separation between the upward optical signals and downward optical signals.

4. The optical transmission system claimed in claim 2, further comprising a plurality of optical multiplexer demultiplexers for making a separation between the upward optical signals and downward optical signals.

5. The optical transmission system claimed in claim 1, further comprising a plurality of optical circulators for making a separation between the upward optical signals and downward optical signals.

6. The optical transmission system claimed in claim 2, further comprising a plurality of optical circulators for making a separation between the upward optical signals and downward optical signals.

7. The optical transmission system claimed in claim 1, further comprising a plurality of optical interleavers for making a separation between the upward optical signals and downward optical signals.

8. The optical transmission system claimed in claim 2, further comprising a plurality of optical interleavers for making a separation between the upward optical signals and downward optical signals.

9. The optical transmission system claimed in claim 2, further comprising:
a plurality of upward amplifiers for amplifying the upward optical signals of different frequencies after multiplexing operation; and
a plurality of downward amplifiers for amplifying the downward optical signals of different frequencies after multiplexing operation.

10. The optical transmission system claimed in claim 2, further comprising:
a plurality of upward amplifiers for amplifying the upward optical signals of different frequencies after multiplexing operation; and
a plurality of downward amplifiers for amplifying the downward optical signals of different frequencies after multiplexing operation;
wherein the upward amplifiers and the downward amplifiers are erbium dope optical fiber amplifiers.

11. An optical transmission method for transmitting optical signals in both upward and downward directions in one and the same fiber, wherein:
the difference between the frequency of upward optical signals and the frequency of downward optical signals is greater than bandwidths assigned to all receivers for receiving the optical signals; and
transmission power of the optical signals is lower than an induced Brilloum scattering threshold.

12. An optical transmission method for transmitting optical signals of different frequencies in both upward and downward directions in one and the same fiber, wherein
the differences between the respective frequencies of upward optical signals and the respective frequencies of downward optical signals are greater than bandwidths assigned to all receivers for receiving the optical signals; and
transmission power of the optical signals is lower than an induced Brilloum scattering threshold.
